(19) United States
(12) Patent Application Publication
(10) Pub. No.: US 2013/0133821 A1
(43) Pub. Date: May 30, 2013

(54) FIBER REINFORCED POLYMER FRAME RAIL

(71) Applicant: Daimler Trucks North America LLC, Portland, OR (US)

(72) Inventors: Maik Ziegler, Portland, OR (US); Justin Yee, Portland, OR (US)

(73) Assignee: DAIMLER TRUCKS NORTH AMERICA LLC, Portland, OR (US)

(21) Appl. No.: 13/748,142

(22) Filed: Jan. 23, 2013

Related U.S. Application Data
(62) Division of application No. 13/029,912, filed on Feb. 17, 2011.
(60) Provisional application No. 61/305,904, filed on Feb. 18, 2010.

(51) Int. Cl. B29C 63/00

(52) U.S. Cl. CPC B29C 63/0073
USPC 156/245

(57) ABSTRACT

Described herein are fiber-reinforced composite members and methods and systems for making the same. The composite members can be any of various types, including load-bearing structural members such as frame rails for a truck chassis. The composite members can be formed directly in a desired shape, such as with a pultrusion process, with irregular features, such as bolt holes, preformed therein without damaging the fibers. The composite members can provide similar or greater overall strength compared to metal members with reduced weight, and can comprise fibers distributed and oriented in such a manner to create additional strength in desired locations and directions and reduced strength in other locations/directions.

### CROSS-REFERENCE TO RELATED APPLICATION

This is a divisional of U.S. patent application Ser. No. 13/029,912, filed Feb. 17, 2011, which claims the benefit of U.S. Provisional Patent Application No. 61/305,904, filed Feb. 18, 2010, both of which are hereby incorporated by reference.

### FIELD

This disclosure pertains to composite members, particularly fiber-reinforced polymer frame rail members for vehicles, such as trucks, with irregular features, such as bolt holes, preformed therein, as well as methods and systems for making such members.

### BACKGROUND

Conventional vehicle frame rails are made of metal, such as steel. For example, a conventional C-rail is made by first forming a flat sheet of steel and then rolling both sides over to form a C-shaped beam. Drilling bolt holes in the rail is then performed in a separate process. These conventional steel frame rails are typically very heavy and have uniform density and strength throughout.

### SUMMARY

Described herein are composite members, such as fiber-reinforced polymer frame rails, and methods and systems for making the same. The composite members can be formed directly in a desired cross-sectional shape with irregular features, such as bolt holes, preformed therein. The composite members can provide similar or greater overall strength than metal members with reduced weight, and can comprise fibers distributed and oriented in such a manner to create additional strength in desired locations/directions and reduced strength in other locations/directions.

Some exemplary embodiments of a frame rail for a vehicle are comprised primarily of a fiber-reinforced polymer composite material. In these embodiments, the frame rail is elongated in a longitudinal direction and includes at least one irregular feature formed therein. Fibers of the composite material adjacent to the perimeter of the at least one irregular feature are oriented to follow the shape of the perimeter of the at least one irregular feature. In some embodiments, the at least one irregular feature can include an aperture passing through the frame rail. In some embodiments, the plural fibers can partially or completely surround the irregular feature. In some embodiments, the plural fibers can have a length greater than the longitudinal length of the irregular feature and the plural fibers can extend unbroken longitudinally past the irregular feature. In some embodiments, the plural fibers diverge from one another in the region of the irregular feature as the plural fibers extend past the irregular feature.

In some embodiments, the frame rail can comprise fibers distributed within the frame rail at least with first and second densities, with the second density being greater than the first density, and fibers of the second density are positioned adjacent to the at least one irregular feature. In some embodiments, the composite material can comprise lignocellulosic fibers, carbon fibers, glass fibers or combinations thereof. In some embodiments, an interior portion of the frame rail can be comprised primarily of a first composite material having a first strength and an exterior portion of the frame rail can be comprised primarily of a second composite material having a second strength, the second strength being greater than the first strength. For example, in some embodiments, the composite material comprises lignocellulosic fibers at an interior portion and carbon fibers at an exterior portion. In some embodiments, the stronger material can be positioned at the interior or located proximal to the irregular features to reinforce those areas.

In some embodiments, the frame rail can include a metal interior portion and the composite material can form an exterior portion overlaying the metal interior portion. The metal interior portion can include at least one feature-forming portion that extends through the composite exterior portion and forms at least one of the irregular features of the frame rail.

An exemplary method of forming a fiber-reinforced composite member can include forming a layup of composite materials and curing the layup. Forming the layup can include combining at least one resin-containing fiber mat and at least one carrier strip. The carrier strip can include an elongated strip carrying spaced apart feature-forming elements and the feature-forming elements can be at least partially embedded within the resin-containing fiber mat. The method can also include curing the layup into a cured composite member having irregular features formed therein at locations where the feature-forming elements are positioned.

The feature-forming elements can be projections projecting from the elongated strip wherein the projections have cross-sectional configurations corresponding to cross-sectional configurations of the irregular features. In some of these embodiments, the projections can be tubes or pegs and the irregular features comprise apertures corresponding to dimensions of the tubes or pegs. In some embodiments, the elongated strip has first and second major sides and the elongated strip carries feature-forming elements projecting from both of the first and second major sides. In some embodiments, at least some of the feature-forming elements can comprise apertures that form at least some of the irregular features and the at least some feature-forming elements can comprise fibers extending completely around the perimeter of the apertures. In some embodiments, at least some of the feature-forming elements can comprise fibers extending radially outwardly from the at least some feature-forming elements and curing the layup can include bonding the fibers with portions of the fiber mat adjacent the at least some feature-forming elements in the layup.

In some embodiments, forming the layup can comprise first applying the resin-containing fiber mat to a surface of a mandrel and then applying the carrier strip to the fiber mat on the mandrel such that the feature forming elements penetrate through the fiber mat and contact the mandrel. In some of these embodiments, the method can further comprise removing at least one carrier strip and the feature-forming elements carried thereon from the cured composite member to expose the irregular features in the cured composite member. In some embodiments, the removed carrier strip can be part of a recirculating loop that is applied to the resin-containing fiber mat prior to curing and separated from the composite member after curing. In some embodiments, the method can further comprise pulling the mandrel through a die such that the mandrel carries the layup through the die. In some embodiments, forming and curing the layup can be continuously performed to create a continuously elongated composite member that is then segmented into a plurality of composite members.

In some embodiments, the cured composite member can be elongated in a longitudinal direction and longitudinal fibers of the composite material adjacent to the at least one irregular feature can be oriented to follow the shape of the perimeter of the at least one irregular feature and extend unbroken longitudinally past the irregular feature.

In some embodiments, forming the layup can further comprise: (1) applying a first carrier strip to a surface of a mandrel, the first carrier strip comprising an elongated strip carrying spaced apart tubes, the elongated strip being positioned against the surface of the mandrel and the tubes extending from the elongated strip away from the surface of the mandrel, the tubes comprising an inner lumen; (2) applying the resin-containing fiber mat onto the first carrier strip on the mandrel such that the tubes penetrate through the fiber mat; and (3) applying a second carrier strip onto the fiber mat on the mandrel, the second carrier strip comprising an elongated strip carrying spaced apart pegs, the pegs being inserted into respective lumens of the tubes. In some of these embodiments, the method further comprises removing the second carrier strip and the pegs from the cured composite member to expose the lumens in the cured composite member.

In other exemplary methods of forming a fiber reinforced composite member having apertures preformed therein, the method can comprises: (1) applying a layup of resin-containing fiber material to a mandrel; (2) inserting at least one object into the layup such that the object penetrates through the layup; (3) curing the layup to form a composite member having the object therein; and (4) removing the object from the composite member to expose a void in the composite member. In some of these methods the object can be inserted into the layup such that the object extends completely through the layup and the exposed void comprises an aperture extending completely through the composite member. For example, the object can be inserted from a first side of the layup and the object can be removed from an opposite side of the composite member. In some embodiments, the object can comprise a material that does not bond with the layup during curing. In some embodiments, removing the object from the composite member can comprise pushing the object from a first side of the composite member to remove the object from an opposite side of the composite member.

The inventive features include all novel and non-obvious features disclosed herein both alone and in novel and non-obvious sub-combinations with other elements. In this disclosure, it is to be understood that the terms “a”, “an” and “at least one” encompass one or more of the specified elements. That is, if two of a particular element are present, one of these elements is also present and thus “an” element is present. The phrase “and/or” means “and”, “or” and both “and” and “or”.

### BRIEF DESCRIPTION OF THE DRAWINGS

FIG. 1 is a perspective view of a C-shaped composite member that can be used as a vehicle frame rail.

FIG. 2 is a cross-sectional view of a C-shaped composite member.

FIG. 3 is a cross-sectional view of an I-shaped composite member.

FIG. 4 is a cross-sectional view of a C-shaped member having an interior reinforcement and a composite exterior.

FIG. 5 is a cross-sectional view of a C-shaped member comprising an interior comprised of one type of reinforced composite material and an exterior comprised of a second type of reinforced composite material.

FIG. 6 is a cross-sectional view of a C-shaped composite member comprising a tube extending through one wall.

FIG. 7 is a cross-sectional view of a C-shaped composite member comprising an interior reinforcement, a composite exterior, and a tube extending through one wall.

FIG. 8 is a plan view of a composite member comprising staggered holes, some elongated reinforcement fibers oriented in a lattice pattern, and other reinforcement fibers wrapped or positioned around the holes.

FIG. 9 is a plan view of a composite member comprising holes and continuous and/or elongated reinforcement fibers oriented along the length of the member and arranged to curve around the holes.

FIG. 10 is a plan view of a composite member comprising a hole and continuous and/or elongated reinforcement fibers oriented along the length of the member and arranged to curve around the hole, and additional reinforcement fibers oriented around the hole in a circular pattern.

FIG. 11 shows an exemplary pultrusion process that can be used to make a composite member in accordance with an embodiment of the disclosure.

FIG. 12 is an exemplary pultrusion system or apparatus for making composite members with holes preformed therein.

FIG. 13 is a diagram of a fiber mat applied as a reinforcement to a second or core material.

FIG. 14 is a diagram of a carrier strip carrying spaced-apart hole-forming pegs in a pre-established pattern.

FIG. 15 is a diagram of a carrier strip carrying spaced-apart hole-forming tubes.

FIG. 16 is a diagram of a carrier strip carrying tubes at intervals, wherein the tubes extend from both sides of the carrier strip or pass through the carrier strip.

FIG. 17 is a diagram of a carrier strip carrying tubes at intervals, wherein reinforcement fibers, which can include projecting fiber strands or strand bundles, extend outwardly from the tubes.

FIG. 18 is a diagram of fiber reinforcement mats applied to opposite sides of a core material, wherein hole-forming tubes extend completely through the reinforcement materials and core material.

FIG. 19 is a diagram of another exemplary system for making composite members with holes preformed therein using a circulating belt.

FIG. 20 is a diagram of yet another exemplary system for making composite members with holes preformed therein, using machines to insert and remove hole-forming rods, tubes or other hole-forming members.

FIG. 21 is a diagram of an exemplary system for applying elongated reinforcement fibers around protruding hole-forming rods.

FIG. 22 is a diagram of reinforcement fibers wrapped around hole-forming rods in a weave pattern.

FIG. 23 is exemplary pultrusion system for making a plurality of composite members simultaneously.

FIG. 24 is a diagram of exemplary extruding and compression molding processes for making composite members.

FIG. 25 shows an exemplary composite material vehicle assembly in an upper portion thereof and individual composite members used in the assembly.

FIG. 26 shows a portion of an exemplary chassis that includes two components coupled together with a T-shaped connecter.

### DETAILED DESCRIPTION

Described herein are embodiments of composite members having irregular features preformed therein and methods and systems for making the same. The members can be any of various types, including load-bearing structural members such as frame rails for a truck chassis. The composite members can be formed by pultrusion, extrusion, sheet molding, compression molding, resin transfer molding, long fiber thermoplastic molding, or other suitable processes.

As used herein, the term “irregular features” means one or more apertures, lumens, holes, openings, tubes, cavities, voids or combinations thereof.

The various composite materials can be combined to form an assembly of components, or a layup. Examples of composite components include various fibers, resins, strengthener, and other additives. Exemplary fibers include carbon fibers, glass fibers, aromatic polyamide fibers, such as Kevlar, and natural fibers, such as lignocellulosic fibers. Exemplary resins include phenolic resins, epoxies, polyesters, vinyl esters, polyetherketones, polyehterimides, polyethersulphones, high density polyethylenes, polycarbonates, acrylonitrile-butadiene-styrenes, polypropylene, nylon, and other thermoplastic and/or thermosetting polymers.

Replacing metal frame rails with composite frame rails can both reduce weight and reduce the number of steps in the manufacturing process. Lighter weight frame rails can result in many advantages, such as improved fuel efficiency, payload capacity, and acceleration/deceleration. Furthermore, multiple processes, such as providing a flat sheet, bending the sheet, and drilling holes, can be combined into a single process.

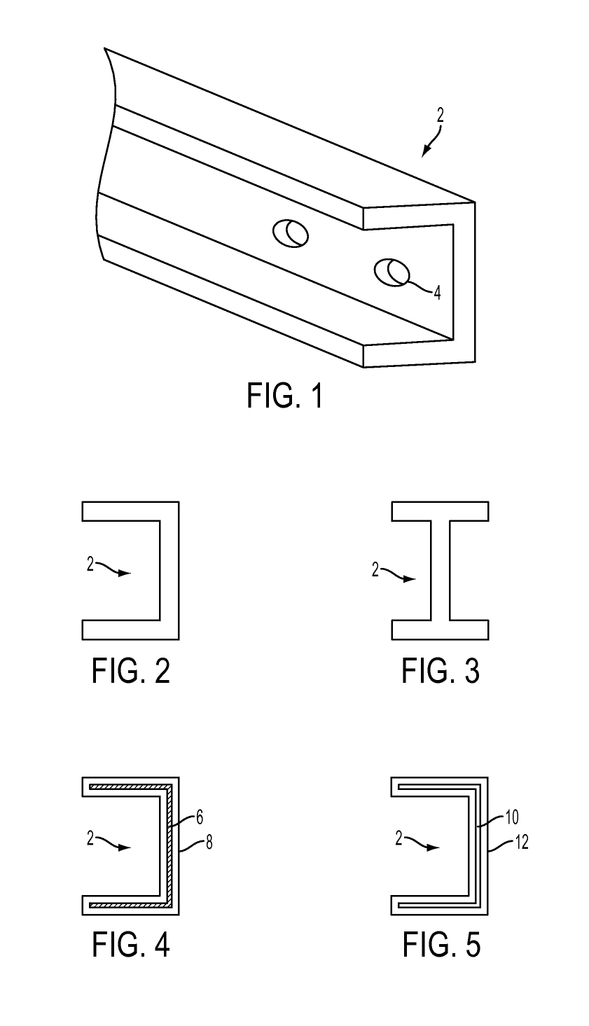

The members can have various profiles. An exemplary composite member 2 having a C-shaped profile is shown in FIGS. 1 and 2. Irregular features 4, such as fastener receiving openings, are preformed in one or more walls of the member 2. Although it is possible to form irregular features 4 in the composite member after the composite member has been completed, desirably all, substantially all, at least a majority, or at least a plurality of the irregular features are preformed. These irregular features 4 can be preformed in desirable pre-established patterns. In other embodiments, irregular features 4 can be preformed in various other locations in the member. FIG. 3 shows an embodiment of a member 2 having an I-shaped cross section. The cross section of these members need not be C-shaped or I-shaped, although these are common configurations for vehicle frame rails.

In the embodiment shown in FIG. 4, the member 2 is formed with an interior portion 6, which can be of metal, such as aluminum, and overlaid, surrounded or coated with an exterior portion 8 comprised of a composite material. The interior portion 6 and the exterior portion 8 can have different densities and strengths.

FIG. 5 shows an embodiment of a composite member 2 with an interior portion 10 comprised of a first composite material and an exterior portion 12 comprised of a second composite material. The first and second composite material can have different densities and strengths. For example, the first composite material can comprise lignocellulosic fibers while the second composite material can comprise carbon fibers, or vice versa. In some embodiments, the member 2 can comprise a fiber or fiber mat reinforcement of a first type of fibers or fiber blend 10 (e.g. carbon fibers, a carbon fiber mat or a blend of carbon and other fibers, such as containing at least some fiber glass fibers, lignocellulosic fibers) adjacent to interiorly facing surface portions of a core and a second type of fibers or fiber blend 12 (e.g. fiberglass fibers or a fiberglass fiber mat with or without other fibers) adjacent to one or more or all outwardly facing surface portions of the core.

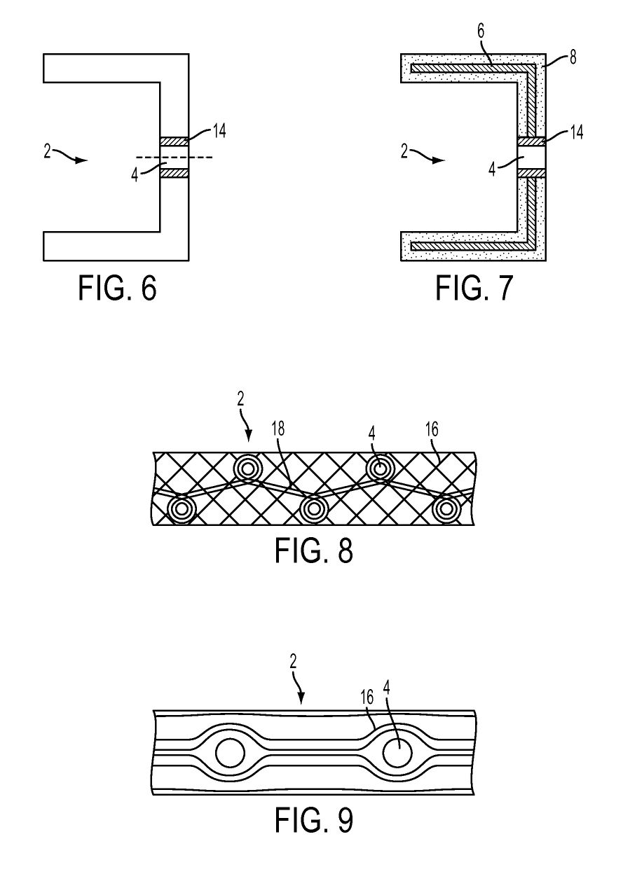

A cross-section of another embodiment of a composite member is shown in FIG. 6. In this embodiment, a hole 4 is surrounded by a tube 14 that is captured by or integrated into the composite member 2, desirably at the time of formation of the composite member. This tube 14 can be formed of composite material itself, or can be formed of one or more other materials, such as metal.

In similar embodiments, a metal interior portion can comprise a feature forming portion that extends through an exterior portion and forms an irregular feature. For example, FIG. 7 shows an embodiment of a member 2 having a tube 14 forming a hole 4, wherein the tube extends through (or tube sections extend outwardly from the opposed side surfaces of) a core or interior portion 6. The tube 14 can be of right cylindrical shape and can also have other configurations. The interior portion 6 can be of metal or other suitable materials. Surfaces of the interior portion 6 are overlaid with composite material 8 leaving an aperture 4 through the member 2, such as a fastener receiving aperture, provided by the lumen of the tube 14. A preformed opening can eliminate the need to drill an opening through the finished composite member that can break fibers and otherwise weaken the member. Alternatively, the tube 14 can be solid (e.g., a peg without an aperture) to provide a potential location through which a fastener or other opening can be drilled or otherwise formed following the formation of the composite member. In the case of a composite frame rail, the lower surface of the frame rail can be provided with a protective surface material, such as metal or another durable material to resist damage to the composite member from rocks and other road debris.

FIG. 8 shows an embodiment of a composite member 2 having several irregular features 4 preformed in a staggered orientation. The irregular features 4 need not be staggered as other arrangements can be used. Some of the fibers 16 that make up the composite material can be oriented at an angle to the longitudinal direction of the member 2. In some embodiments, the fibers 16 are oriented in a lattice pattern. In some of these embodiments, the fibers 16 of the lattice can be oriented at plus/minus about 45-degrees to the longitudinal direction of the member 2. Some of the fibers 18 can also be configured to extend completely and/or partially around the perimeter of the irregular features 4 to provide additional strength at those locations. In other embodiments, the fibers can be configured in various other patterns, densities and alignments.

Plural fibers of the composite material adjacent to the perimeter of an irregular feature can be oriented to follow the shape of the perimeter of the irregular feature. In some embodiments, the fibers completely and/or partially surround the irregular feature. In embodiments where fibers have a length greater than the longitudinal length (e.g., the diameter or width) of the irregular feature, the fibers can extend unbroken longitudinally past the irregular feature. By contrast, if the member was formed without the irregular features and the irregular features were later formed by drilling or similar means, the fibers in the region of the irregular feature would be broken or severed, weakening the member. By forming the irregular features before curing, the malleable fibers can be diverged or separated apart to make room for the irregular features without damaging the fibers such that the fibers remain continuous and unbroken around the irregular features.

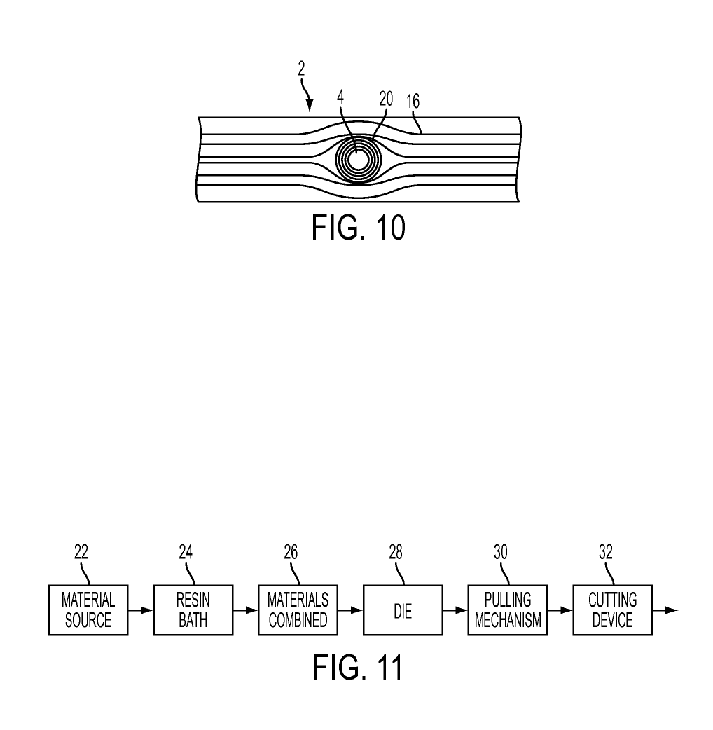

In some embodiments, as shown in FIG. 9 for example, the fibers 16 can be oriented generally parallel to the longitudinal direction of the member 2. In these embodiments, the fibers can be configured to diverge laterally adjacent the irregular features 4 to maintain a continuous fiber path around irregular features. One variation of this embodiment is illustrated in FIG. 10, wherein a group of annular fibers 20 are positioned to extend completely and/or partially around the perimeter of the irregular features 4, in addition to the longitudinal fibers 16. In some of these embodiments, fibrous tubes can be used to form the group of annular fibers 20.

An exemplary general process for making the composite members 2 can include pulling and/or pushing a plurality of composite materials (such as fiber mats) through one or more resin baths, combining the plurality of composite materials together to form a layup, and moving the layup through a die or mold wherein the layup can be formed in a desired shape and cured. In the case of thermoset resins, the resin-containing reinforcement fibers can be thermally set as part of the process.

A flow diagram of one embodiment of a general pultrusion process is diagramed in FIG. 11. Individual composite materials are drawn from material sources 22 through a resin bath 24. The composite materials are combined at 26, and then moved through a forming and/or curing die 28. After passing a pulling mechanism 30, the pultruded member is cut into segments (e.g. into frame rails in the case of a vehicle frame rail manufacturing process) by a cutting device 32.

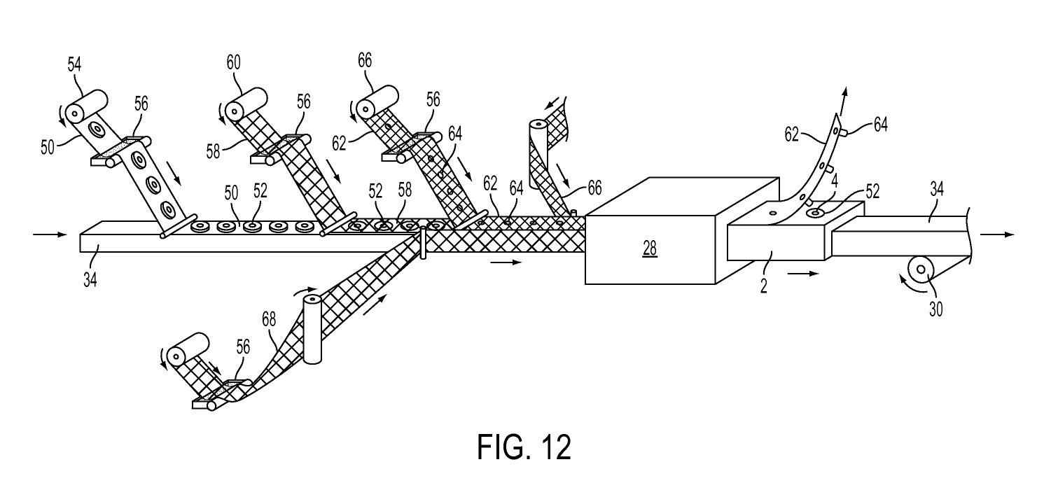

In some pultrusion processes, for example, a pulling mechanism 30 can comprise a rotating sprocket or gear, a pair of rotating cylinders, a caterpillar type conveyor belt, and/or reciprocating pullers. The pulling mechanism 30 can pull a mandrel 34 (see for example FIG. 12) carrying the composite member 2 through a die 28 and thereby pull the various composite materials laid up onto the mandrel into the die 28. The mandrel 34 can also have a special surface, such as a ridged or notched bottom surface, to engage the pulling mechanism 30 and prevent slippage. In other embodiments, no mandrel is included and/or a pulling mechanism pulls directly on the composite member 2.

A core of the composite material, if included, can function as a mandrel that remains in the composite member following completion of the member. Such a process can be continuous such that raw materials are continually provided into a die from bulk sources, such as spools or reels, and continually moved through the die and out the other side. The continuous product can then be separated into individual units. Although less desirable, a batch process can also be used.

With reference to FIG. 12, a rigid carrier mandrel 34 can be used to support the composite materials moving into a die 28. The mandrel 34 can both transport the composite materials and act as a base to shape the material around. For example, a rectangular mandrel 34 can receive layers of composite materials on its upper surface and two side surfaces, as shown in FIG. 12, forming an upside-down U-shape. The mandrel 24 can carry the composite materials in a desired shape through the die 28 where the materials can be cured and/or solidified. Upon exiting the die 28, the mandrel 34 can be separated from the rigid composite materials, leaving a solid composite member 2 in the upside-down U-shape. Such a member 2 can form a C-rail for a vehicle frame, for example. In other embodiments, more than one mandrel and/or mandrels of different shapes can be used to created members having other profile shapes. For example, a tube-shaped, or fully enclosed, composite member can be formed by covering all four sides of a rectangular mandrel with composite materials.

Alternatively, a mandrel 34 can be left in the composite member. For example, as shown in FIG. 4, a C-shaped metal mandrel can form the metal base portion, or core, 6, which can then be coated with composite materials 8 on all sides, thereby forming a member 2 with a metal interior and a composite exterior.

Exemplary processes for making composite members 2 can include pulling and/or pushing a mandrel through a die, and thereby carrying composite materials along with the mandrel through the die. These processes can also include both pulling the mandrel from the die and pushing the mandrel into the die.

In some composite-forming processes, a member 2 having more than one discontinuous surface is created. For example, when forming a tubular composite member, an inner and an outer surface must be formed. However, the same device, such as a die, may not be capable of forming both surfaces. In the example of a tubular member, a mandrel can be used to from the inner surface while a die forms the outer surface. In such a process, the mandrel can be suspended such that it extends through the die and out the other side without contacting the die. The mandrel can have a concentric yet narrower profile compared to the inner profile of the die. The composite materials can be fed into the die between the outer surface of the mandrel and the inner surface of the die, thus forming a tubular member.

In some composite-forming processes, more than one member can be created at the same time. For example, two members can be created side-by-side with a single system having two dies or single die having two member-forming compartments.

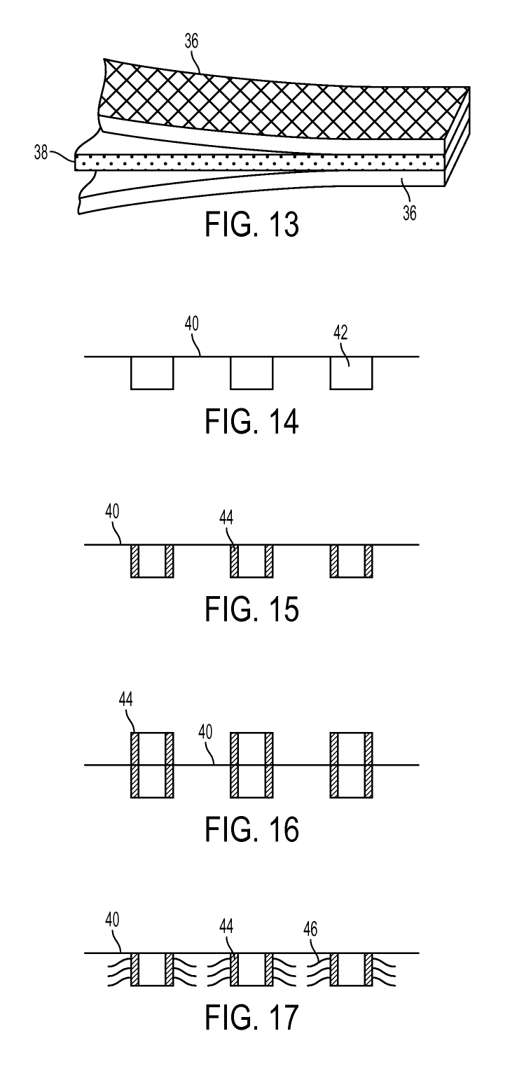

Composite materials can be applied to a mandrel (or otherwise, if no mandrel is used) in different manners, such as in layers. For example, different layers of composite material can be applied to different surfaces of the mandrel. Multiple layers can also be applied on top of one another other. The layered composite materials can be in the form of mats, tapes, films, sheets and/or fabrics, for example. One example is shown in FIG. 13, wherein woven fiber mats 36 are applied to the outer surfaces of a core material 38. Fiber mats can comprise a plurality of fibers preassembled in a predetermined configuration relative to one another. Fiber mats can be free of resin or can be impregnated with or otherwise contain resin. Individual fibers or groups of fibers can also be applied in strands, strips, strings and/or coils, for example.

The fibers can be applied in different concentrations and/or orientations at different locations. For example, higher concentrations of fibers can be applied in locations and/or directions within a composite frame rail where high stress is expected, such as around bolt holes or other connection points. Similarly, the fibers can be applied in different orientations and patterns to create desired structural properties in the final frame rail. Also, different types of fibers and/or fiber concentrations can be applied in different locations. For example, weaker and/or cheaper fibers and/or lower concentrations of fibers can be applied or used as reinforcement in low expected stress regions (where lower stress would be encountered when the member is in use, such as internal regions and/or inwardly facing surface regions), while stronger reinforcement materials and/or greater concentrations of reinforcement materials can be used as reinforcement in high expected load stress regions (such as outer surface regions and/or attachment regions). In the embodiment shown in FIG. 5, a C-shaped member 2 can be formed having weaker natural fibers 10 (e.g. lignocellulosic fibers) in the interior and stronger carbon fibers 12 on the exterior, for example.

The composite member 2 exiting the die can have a desired profile shape caused by the shape of the mandrel 34 and/or the shape of the die 28. For example, the mandrel 34 and/or the die 28 can form the material into a sheet, a rod, a tube, a C-channel, an I-beam, or various other profile shapes. Because of the nature of the composite curing process, the product exiting the die 28 can be solid and rigid and not further deformable without damaging the composite material. In other processes, the material exiting the die 28 can be ductile such that further shape changes can be made.

To introduce irregular features to a composite member, such as bolt holes or other types of fastener apertures, additional feature-forming objects or elements can be added to the member-forming process before and/or after the composite materials move through the die 28. For example, a rod or peg or dowel can be added to the composite materials prior to entering the die, formed within the composite member by the die, and then removed from the composite member after it exits from the die. When the rod is removed, the void left behind can function as, for example, a bolt hole. In one example, the rod can be introduced ahead of the die in an orientation perpendicular to the direction of flow through the die, thereby providing a hole (when the rod is removed) that is perpendicular to the longitudinal axis of an elongate composite member. The rod can have a length that is substantially equal to a dimension of the die and/or the mandrel such that the resulting hole extends all the way through the composite member.

In addition to a rod, various other feature-forming objects can be added to form irregular features. Some examples can include a tube, a sheet, a tape, and a block. The added feature-forming objects that form the irregular features can be comprised of materials that provide desired characteristics. If the feature-forming objects are to be removed, such as a rod that is removed to from a hole, the feature-forming objects can comprise material that does not bind or bond to the adjacent composite materials. Such a material can also be chosen to withstand the maximum temperature levels within the die (e.g., temperatures used to thermoset the composite member if thermoset resin or resins are used). The material of the feature-forming objects can also be chosen to form a low friction contact with the surrounding composite material such that less pressure is required to remove the added objects from the composite member. Mylar and nylon are exemplary suitable materials. The feature forming objects can also be coated with such material.

The feature-forming objects may alternatively be left in the composite member. Objects that are left in the composite member can be allowed the bind with the other composite materials to add desired features to the composite member. For example, a tube can be added that is to remain in the composite member and form a fastener receiving hole or other aperture. The tube itself can be a composite material. For example, the tube can consist of or comprise composite fibers running in a circumferential direction around an inner hole-forming opening. Fibers can also extend radially outwardly from the tube for bonding with surrounding portions of the composite member. These fiber orientations can strengthen the composite material that surrounds the resulting irregular feature in the composite member. Alternatively, a solid rod with fibers wrapped around it can be added such that when the rod is removed or penetrated such as by drilling, a reinforced hole is left behind.

In other embodiments, a feature-forming object can be added to the composite materials that can be later removed by mechanical or chemical processes, leaving a void, such as a bolt hole, in the resulting composite member. For example, an object in the composite member can be drilled out, dissolved, etched, or melted, leaving a desired void.

In some embodiments, objects can be added to the composite materials that act as spacers to maintain a more precise wall thickness in the composite member. For example, solid blocks can be added to the composite materials that are spaced around the mandrel and that have a specific thickness that is substantially equal to the desired composite member wall thickness in each respective location. Such spacers can keep the mandrel properly located relative the die.

Objects can be added to the composite materials in various manners to locate the resulting features in desired positions in the composite member. In one exemplary method, an elongated tape, or carrier strip, is used having feature-forming objects pre-applied to, or in, the strip at desired intervals and/or locations. The feature-forming elements can comprise projections projecting from the elongated strip such that the projections have cross-sectional configurations corresponding to cross-sectional configurations of the irregular features to be formed in the resulting composite member.

FIG. 14 illustrates one embodiment of a carrier strip 40 carrying pegs, or rods, 42. After a composite member is cured, the carrier strip 40 and the pegs 42 can be peeled away, or otherwise removed, from the composite member to expose irregular features in the composite member corresponding to the shape of the pegs.

An embodiment of a carrier strip 40 carrying tubes 44 is shown in FIG. 15. The tubes 44 can comprise fibers oriented circumferentially around the inner lumens of the tubes such that the fibers extend completely and/or partially around the perimeter of the lumen. After a composite member is cured, the carrier strip 40 and the tubes 44 can be left in the composite member and the lumens of the tubes can form irregular features in the composite member.

As shown in FIG. 12, a carrier strip 40 can be dispensed from a spool and positioned onto a surface of the mandrel along with other composite materials prior to entering the die 28 such that the feature-forming objects carried by the carrier strip are dispersed on or in the resulting composite member 2 at predetermined locations. As the carrier strip 40 is combined other composite materials, the feature-forming elements can penetrate or extend through the other composite materials (e.g., penetrate between and separate the fibers of a resin-soaked fiber mat) and/or become embedded within other composite materials. In some cases, the feature forming elements can penetrate all the way through the other composite materials, such as to form an aperture in the resulting composite member. For example, a carrier strip applied to a top or outer surface of a layup of other composite materials can comprise aperture-forming pegs or tubes than extend all the way through the other composite materials and contact a mandrel on which the layup is carried.

In some embodiments, a carrier strip 40 can hold rods 42 or tubes 44 such that the feature-forming objects project from both sides of the carrier strip. One such embodiment is shown in FIG. 16. The carrier strip 40 can then be sandwiched between other composite material layers and left in the composite member 2.

In some methods, at least some of the feature-forming elements added to the layup comprise tubes having fibers extending radially outwardly from the tubes. During curing of the layup, the radially extending fibers bond with portions of the adjacent composite materials to reinforce the irregular features. For example, as shown in FIG. 17, a carrier strip 40 can also carry tubes 44 comprised of fibers and/or having loose fibers 46 that can extend radially into and bond with the surrounding material.

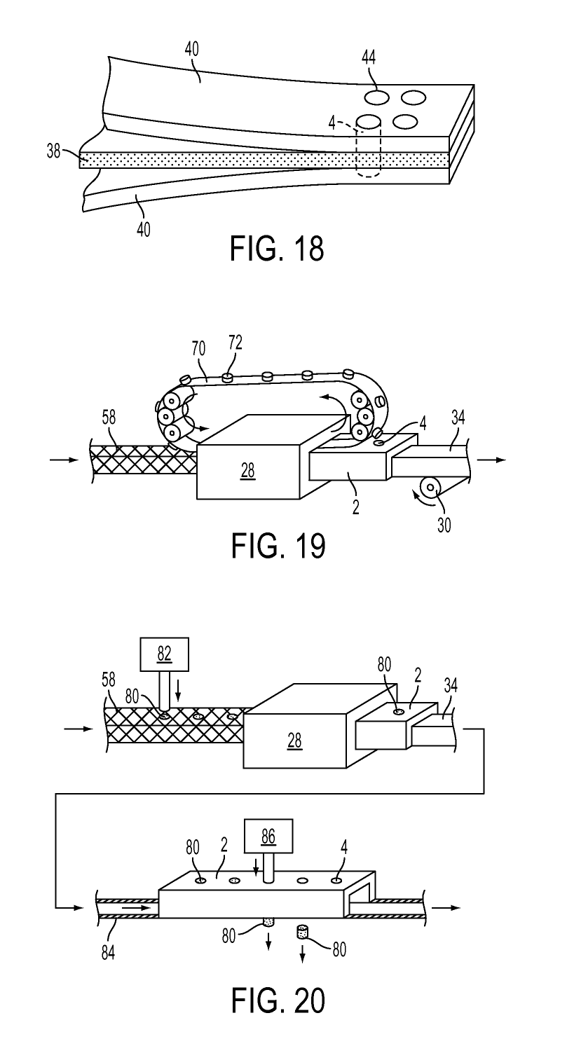

In some embodiments, such as in FIG. 18, a carrier strip 40 can be applied to opposite sides of a core material 38 such that corresponding tubes 44 in each carrier strip penetrate through the core material 38 and mate together to form a hole 4 running completely through the materials. Such a carrier strip 40 can comprise fibrous reinforcement that is impregnated with resin and that remains with the core material 38 in the resulting composite member. In one example, the top tubes 44 or portions thereof in FIG. 18 can have male ends and the bottom tubes 44 or portions thereof can have female ends that mate together within the core material 38.

Several exemplary methods of creating composite members having irregular features are described herein. In the exemplary pultrusion system shown in FIG. 12, a thin fibrous carrier strip, or tape, 50 having tubes 52 affixed therein at desired locations can be applied to the upper surface of a mandrel 34. The tubes comprise an inner feature-forming lumen. The tape 50 can be fed from a spool 54, through a resin bath 56, and onto the upper surface of the mandrel 34. The tape 50 can be indexed so as to be applied to the mandrel and a desired position relative to the application of other object-forming tapes, if used, so that a desired pattern of openings can be provided in the resulting composite member.

A fiber mat 58 can be fed from a spool 60, through a resin bath 56, and onto the outer surface of the tape 50. The mat 58 can comprise the bulk of the fiber reinforcement that will make up the upper surface of the composite member 2. The mat 58 can be approximately as thick as the tubes 52. The mat 58 can have a desired fiber reinforcement pattern therein (e.g. with selected quantities of fibers oriented in a lattice pattern). As the mat 58 is applied on top of the tape 50, the tubes 52 can penetrate through the mat and such that the upper surfaces of the tubes are exposed on and/or flush with the outer surface of the mat 58. Another carrier strip, or tape, 62 having pegs 64 projecting downwardly therefrom can be fed from a spool 66, through a resin bath 56, and applied to the upper surface of the mat 58 and/or the upper surfaces of the tubes 52, such that the pegs 64 are inserted into the lumens of the tubes 52. Fiber mats 62 and 68 can similarly be applied to the side surfaces of the mandrel 34 to form the side portions of the composite member 2. These mats can also contain and/or receive hole-forming tubes and pegs in the same manner as mat 58 if desired (not shown in FIG. 12).

The mandrel 34 can be pulled through the die 28 by a pulling mechanism 30 that grips the bottom surface of the mandrel and continuously rotates. The mandrel 34, having the various layers of composite materials applied to the top and two sides, is pulled into the die 28 wherein the composite materials are set/cured and become a composite member 2. The composite materials are continuously dispensed onto mandrels and pulled through the die such that a continuously elongated composite member is formed. The composite member can be made to any length by continuing the process for an appropriate length of time and feeding in additional lengths of mandrels as needed. Typically, however, the elongated composite member exiting the die is regularly segmented into individual members of desired length.

Upon exiting the die 28, the top layer of tape 62 can peeled off, pulling the pegs 64 from the tubes 52, and leaving holes 4 in the member 2. The pegs 64 can be comprised of a material (e.g., metal or thermoset polymer) that can withstand the high temperature of the die 28 without melting. The material can also be selected such that the pegs do not bond with the surrounding materials during the curing process and/or creates a low coefficient of friction between the pegs and the composite member. A mold release coating can optionally also be applied to the pegs 64 and/or the tubes 52 to facilitate removing the pegs from the tubes. After the tape 62 is removed, the member 2 is conveyed on the mandrel 34 away from the die 28 where the member can be cut or otherwise separated into segments.

In some embodiments, the mandrel 34 can be comprised of segments, such that when a segment fully exits the die and is separated from the composite member 2, the mandrel segment can be moved back behind the segment(s) that are being pulled into the die, creating a continuous cycle.

There can be a number of alternatives to this exemplary system. In one variation, for example, fiber mats are only applied to two sides of the mandrel 34, forming an L-shaped member 2. In another variation, the tape 50 carrying the tubes 52 can be applied to the sides of the mandrel 34 in addition to, or instead of, the top surface, resulting in holes 4 in different portions of the composite member 2.

In other embodiments, the carrier strip 62 can be replaced with a circulating belt or loop that is fed into the die 28 with the composite materials, pulled apart from the composite member 2 upon exiting the die, and looped back around to be cyclically re-applied with hole or void forming members 52 remaining on the belt for use in making the subsequent composite members.

FIG. 19 shows an exemplary system for forming irregular features, such as holes, 4 in the top surface of a composite member 2. A pulling device 30 pulls a mandrel 34 from a die 28. The mandrel 34 carries resin-soaked fiber mats 58 on its surfaces into the die 28 wherein the composite materials are set and formed into a solid member 2. A cyclical, or recirculating, belt 70 can be included that carries feature-forming elements, such as pegs, 72 fixed at desired intervals. The belt 70 can be applied to the outer surface of the top fiber mat 58 before the mat 58 enters the die 28. As the belt 70 is applied to the mat 58, the pegs 72 are inserted into the mat and the belt 70 rests on top of the mat. The pegs 72 can penetrate all the way through the mat 58 and contact the mandrel 34, or only partially penetrate the mat. In some embodiments, the mat 58 can be pre-cut to form peg receiving holes to facilitate insertion of the pegs 72. As explained above, fiber tubes or other members can be inserted into these pre-cut holes to facilitate receiving and releasing the pegs 72. After exiting the die 28, the belt 70 is conveyed away from the member 2, pulling the pegs 72 from the member. When the pegs 72 are removed, holes 4 are left behind in the member 2. The belt 70 can be continuously cycled such that the same pegs 72 can be re-used to create a repetitive set of holes in each successive composite member having the desired hole pattern.

Other exemplary methods of applying added objects to a composite member can include the use of one or more machines to inject or insert the added objects into the composite materials and/or one or more machines to remove the added objects from the composite member. Such machines can be responsive to manually applied signals, such as a user pressing a button, or the machine can respond to signals from a controller, such as a programmed computer. In certain embodiments where more precise positioning is necessary, a computer-controlled machine can insert the added objects at more precisely determined intervals and/or locations.

FIG. 20 shows an exemplary system wherein rods, or other hole-forming objects, 80 are inserted into a fiber mat 58 before entering a die 28, and then removed after exiting the die. An object insertion machine 82 is arranged to inject rods 80 into the fiber mat 58 at precise intervals and/or locations as the mat is conveyed past the machine 82. The members 80 are left in the mat 58 as the composite materials are set in a die 28. The resulting solid member 2 is then removed from the mandrel 34 and conveyed on a conveyor 84 past an object removal machine 86. The second machine 86 punches or otherwise removes the hole-forming objects 80 out of the member 2 and/or drills the hole-forming objects, leaving behind holes 4.

In some embodiments, the added objects can be added after the composite member 2 exits the die 28. Certain composites, such as those comprising thermoplastic polymers, can be softened again after being set by a die. These composites can be reheated temporarily after exiting the die to make the material soft enough to insert added objects. In other embodiments, the composite materials can be partially set within the die, leaving them soft enough for added object insertions.

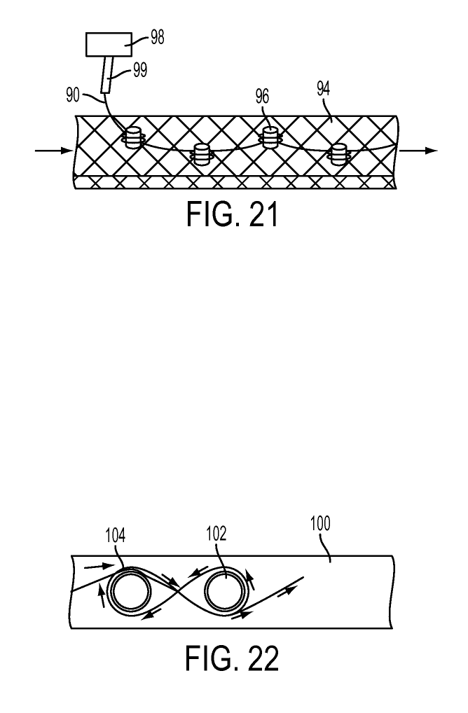

FIG. 21 shows an exemplary system and method for wrapping fibers 90 around protruding rods or tubes 96. The system segment shown can be a portion of a larger system, such as that shown in FIG. 12. After a tape or mat is applied to a surface of a moving mandrel and before the material enters a die, additional fibers 90 can be applied in desired locations to reinforce those areas. In FIG. 21, a mat 94 comprises protruding pegs 96 spaced in a staggered pattern. As each peg 96 passes by a machine 98, the machine can use a guide arm 99 to wrap a continuous fiber 90 around the peg 96 one or more times, and then guide the fiber to the next peg in a continuous process. The machine 98 can include or be couple to a bulk supply of the fiber 90 and/or a resin bath, such that the dispenser arm 99 can coil the resin-soaked fiber 90 around each peg 96. The machine 98 can be computer controlled and operated to dispense the fiber 90 in desired patterns. After passing through a die, the fiber-reinforced pegs 96 can then be removed, leaving a reinforced hole. Alternatively, the pegs 96 can be hollow tubes and left in the member 2. Instead of wrapping the pegs 96 with additional fiber reinforcement, tubes comprising, or pre-wound with, fiber reinforcement can be placed around the pegs. The additional reinforcement in these areas can strengthen the composite member in the area adjacent to the openings.

FIG. 22 shows an exemplary carrier strip 100 with two pegs, or tubes, 102 protruding therefrom. In this example, a continuous fiber 104 is wrapped around the pegs/tubes 102 in a weave or figure-8 pattern. The fiber 104 can also be pre-applied to the carrier tape 100 in a separate process such that the carrier tape, with pegs/tubes 102 pre-wrapped with fibers, can be fed from a bulk source, through a resin bath, and onto the mandrel.

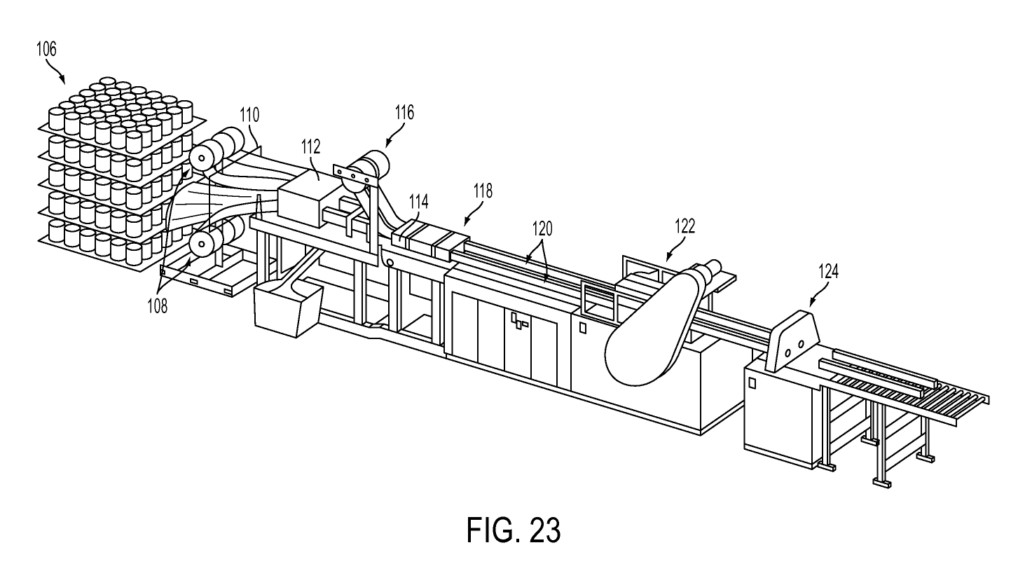

Another exemplary pultrusion system is shown in FIG. 23. In this system, individual fiber rovings 106 and continuous strand mats 108 are pulled through a guide such as guide plates 110 and into a resin impregnator 112. The rovings 106 and the mats 108 are then pulled through a preformer 114 where a surfacing veil 116 is added to the outer surfaces of the rovings and mats. Next, the materials are pulled through a forming and curing die 118 to form solid composite members 120. The members 120 pass through a pulling system 122 and then are segmented by a cut-off saw 124. The pulling system can include caterpillar-like tread pullers and/or reciprocating pullers, and can pull directly on the members 120. The system in FIG. 23 can produce two members 120 side-by-side using dual dies 118. The system of FIG. 23 can also include additional components for introducing carrier tapes and/or other means for adding objects to the composite materials to form irregular features in the composite members 120.

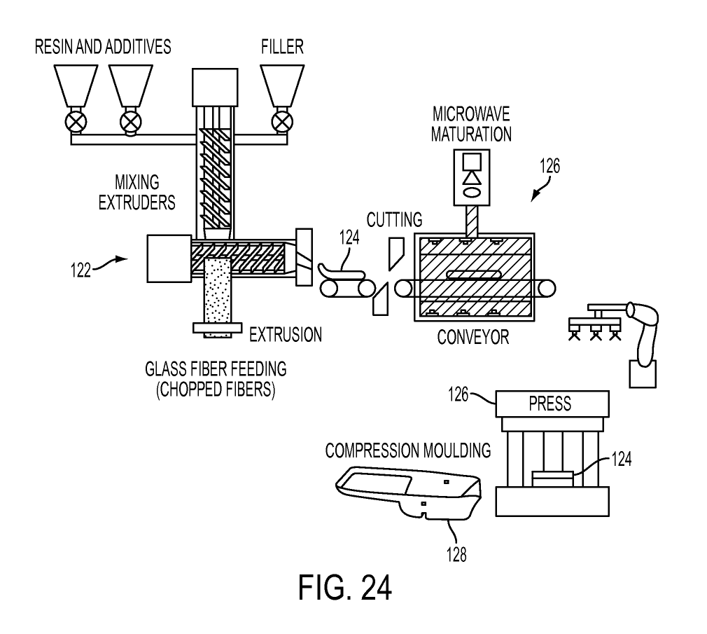

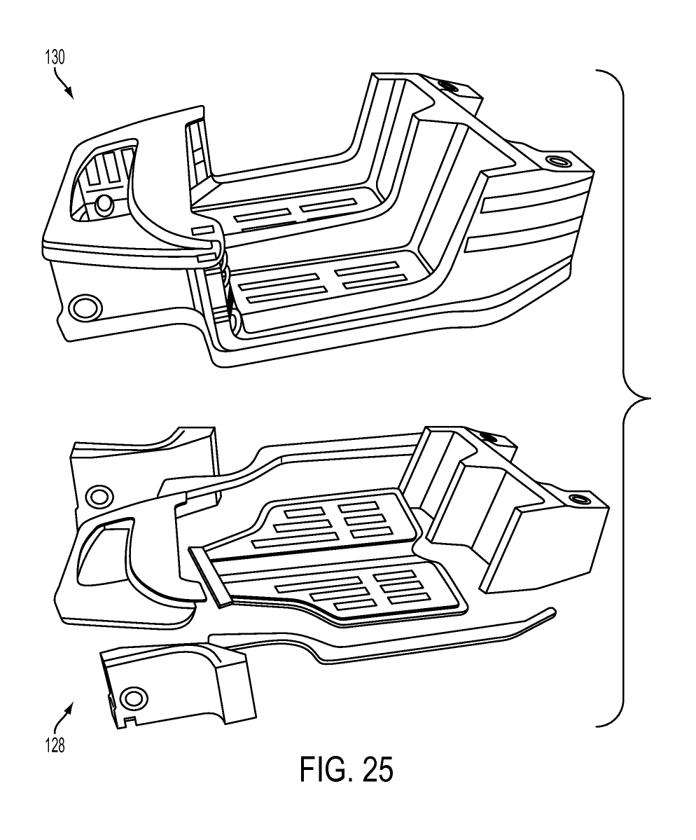

The construction of composite chassis parts, such as frame rails and cross members for a car or truck, can also include processes other than pultrusion. FIG. 24 shows one such process for making a layered composite member from carbon, glass, and/or other fibers. In a first stage 122, resin, fibers, filler, and additives are mixed together. Then the mixture is extruded into sheets 124 or other uniform shapes and cut into segments. The sheets 124 can have different fibers, fiber blends and/or concentrations and orientations of fibers at different locations of the composite member. For example, relatively high strength reinforcement fibers of a first strength, such as carbon fibers and/or fiber blends can be positioned at or adjacent to one surface of a vehicle body part, such as a surface that is more likely to be more highly stressed, such as an exterior surface of the vehicle body part. In addition, relatively lower strength reinforcement fibers of a second strength less than the first strength, such as natural fibers, can be positioned at or adjacent to another surface of the body part, such as a surface that is more likely to be less highly stressed, such as an interior surface of the vehicle body part. The composite material can be partially cured or matured, such as with heat or microwaves at 126. The matured sheets 124 can be formed into desired shapes such as by pressing, and/or by heating and pressing, in a compression molding machine 126 and allowed to cool or cure into the final desired shape. Such sheet molding processes can be used to form various components, such as vehicle chassis or other components 128. FIG. 25 shows several such components 128 for a vehicle at 130. The sheet molding process can be designed according to the load path of each member 128, taking into account the affect of the devices mounted to each component.

Regardless of the construction process of fiber reinforced polymer frame rails, features can be added to the rails to protect from them from being damaged by objects on a roadway. For example, a plate can be added to an outer surface of a frame rail to protect it from damage from loose stones on a roadway. Such a plate can be made of metal or other suitable material and can prevent chips, dents microcracks, and other forms of damage to the frame rail.

Frame rails can be connected to other components of a chassis, such as other frame frails or cross members. Exemplary methods of connecting the components include gluing, welding, bolting, or interconnecting mating parts. Welding is not preferable for fiber reinforced polymer members because the high temperatures can damage the composite material. In a glued joint, the strength of a glued joint is related to the surface areas glued together.

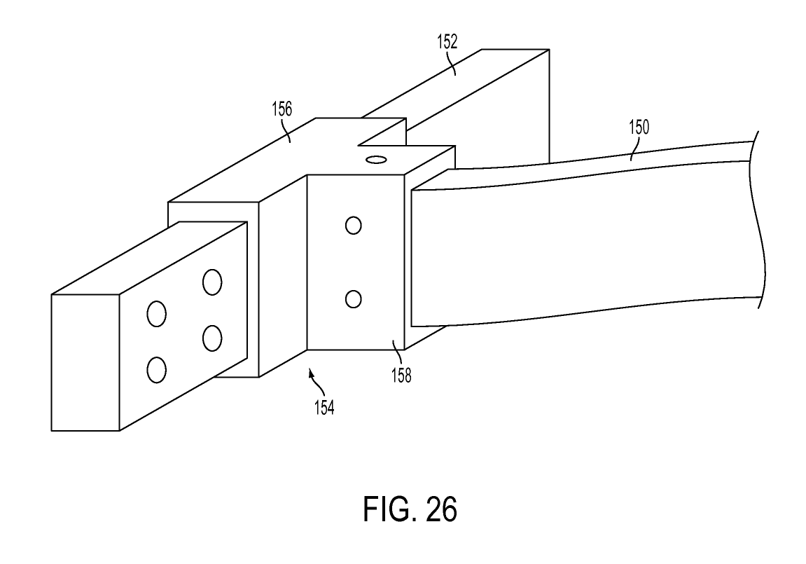

In one example, a first member comprising a rectangular tube is provided and a second narrower rectangular member is telescoped inside of the first member. This creates surface contact areas on all four sides that can be glued. This can result in two members glued together in a same linear path. In another example, shown in FIG. 26, a cross member 150 can be glued to a frame rail 152 using a T-shaped connecter component 154 such that the cross member 150 is roughly perpendicular to the frame rail. The connecter 154 can have a tubular cross portion 156 and tubular trunk portion 158 extending from the cross portion roughly perpendicularly. The cross portion 156 of the connector 154 can be slid over the frame rail 152 and glued such that the inside surfaces of the connector are adhered to the outside walls of the frame rail. Similarly, the cross member 150 can be telescoped into the trunk portion 158 of the connector 154 such that the outer surfaces of the cross member are adhered to the inner surfaces of the connector.

A connector component, such as connector 154, can be made using a batch process, such as sheet molding or resin transfer molding. Crossbeams can be made by the above described pultrusion processes or by batch processes. Curved or bent cross members are more preferably made using batch processes.

Having illustrated and described the principles of the invention with reference to a number of embodiments, it should be recognized that the illustrated embodiments are only preferred examples and should not be taken as limiting the scope of the disclosure. The illustrated embodiments may be modified in arrangement and detail without departing from these inventive principles. We claim all such modifications and arrangements that fall within the scope of the following claims.

We claim:

1. A method of forming a fiber-reinforced composite member, the method comprising:
combining at least one resin-containing fiber mat and at least one carrier strip to form a layup, the carrier strip comprising an elongated strip and spaced apart feature-forming elements coupled to the elongated strip, the feature-forming elements being at least partially embedded within the resin-containing fiber mat;
curing the layup into a cured composite member having irregular features formed therein at locations where the feature-forming elements are positioned.

2. The method of claim 1, wherein the feature-forming elements comprise projections projecting from the elongated strip, the projections each being associated with a respective one of the irregular features, the projections each having a cross-sectional configuration corresponding to the cross-sectional configurations of the respective associated irregular feature.

3. The method of claim 2, wherein the projections comprise tubes or pegs and the irregular features comprise apertures corresponding to dimensions of the tubes or pegs.

4. The method of claim 2, wherein the elongated strip comprises at least first and second major sides and wherein the elongated strip carries feature-forming elements projecting from both of the first and second major sides.

5. The method of claim 2, wherein at least some of the feature-forming elements comprise apertures that form at least some of the irregular features, and the at least some feature-forming elements comprise fibers extending completely around the perimeter of the apertures.

6. The method of claim 1, wherein at least some of the feature-forming elements comprise fibers extending radially outwardly from the at least some feature-forming elements, and wherein curing the layup comprises bonding the fibers with portions of the fiber mat adjacent the at least some feature-forming elements in the layup.

7. The method of claim 1, wherein forming the layup comprises:
applying the resin-containing fiber mat to a surface of a mandrel; and
applying the carrier strip to the fiber mat on the mandrel such that the feature forming elements penetrate through the fiber mat and contact the mandrel.

8. The method of claim 7, further comprising removing at least one carrier strip and the feature-forming elements coupled thereto from the cured composite member to expose the irregular features in the cured composite member.

9. The method of claim 8, wherein the removed carrier strip comprises a recirculating loop that is applied to the resin-containing fiber mat prior to curing and separated from the composite member after curing.

10. The method of claim 7, further comprising pulling the mandrel through a die such that the mandrel carries the layup through the die.

11. The method of claim 10, wherein forming and curing the layup is continuously performed to create a continuously elongated composite member that is then segmented into a plurality of composite members.

12. The method of claim 1, wherein the cured composite member is elongated in a longitudinal direction and wherein plural fibers of the composite material adjacent to the at least one irregular feature are oriented to follow the shape of the perimeter of the at least one irregular feature and extend unbroken longitudinally past the irregular feature.

13. The method of claim 1, wherein forming the layup further comprises:
applying a first carrier strip to a surface of a mandrel, the first carrier strip comprising an elongated strip and spaced apart tubes coupled to the elongated strip, the elongated strip being positioned against the surface of the mandrel and the tubes extending from the elongated strip away from the surface of the mandrel, the tubes comprising an inner lumen;
applying the resin-containing fiber mat onto the first carrier strip on the mandrel such that the tubes penetrate through the fiber mat; and
applying a second carrier strip onto the fiber mat on the mandrel, the second carrier strip comprising an elongated strip and spaced apart pegs coupled to the elongated strip, the pegs being inserted into respective lumens of the tubes.

14. The method of claim 13, further comprising removing the second carrier strip and the pegs from the cured composite member to expose the lumens in the cured composite member.
